(19) United States
(12) Patent Application Publication
(10) Pub. No.: US 2022/0036346 A1
(43) Pub. Date: Feb. 3, 2022

(54) SYSTEMS AND METHODS FOR RE-ORGANIZING BLOCKCHAINS FOR EFFICIENT OPERATIONS

(71) Applicant: Sensoriant, Inc., Cedar Knolls, NJ (US)

(72) Inventors: Shamim A. Naqvi, Morristown, NJ (US); Robert Frank Raucci, New York, NY (US); Goutham Puppala, Basking Ridge, NJ (US)

(21) Appl. No.: 16/940,648

(22) Filed: Jul. 28, 2020

(51) Int. Cl. G06Q 20/38; G06Q 20/06

(52) U.S. Cl. CPC G06Q 20/389; G06Q 2220/00; G06Q 20/3829; G06Q 20/0658

(57) ABSTRACT

In a method for recording a transaction between first and second transacting network nodes associated with a global blockchain is provided. The transacting nodes are associated with a selected sub-chain of the global blockchain. The selected sub-chain is selected from among a plurality of sub-chains of the global sub-chain. In response to the first transacting node causing cryptocurrency to be sent to a first public address associated with the second transacting node as part of a transaction between the first and second transacting nodes, the given transaction is recorded in the selected sub-chain. Subsequent to recording the given transaction, the transaction recorded on the global blockchain using a second public address of the second transacting network node. The recording is performed using an atomic commit process that prevents the first and second transacting nodes from conducting any other transactions while the given transaction is being recorded on the global blockchain.

### BACKGROUND

A blockchain is a peer-to-peer, electronic ledger which is implemented as a computer-based decentralized, distributed system made up of blocks which in turn are made up of transactions. A transaction is an action carried out by a computer program that changes the state of the ledger. For example, an action may add an entry to a ledger recording a payment to a user identified by the digital address of the user. (In blockchain systems, users are typically identified by addresses which are usually sequences of binary digits.) In blockchain systems, a transaction is represented by a data structure that encodes the transfer of control of an asset between users of the blockchain system, and includes at least one input user and at least one output user.

Each block contains a hash of the previous block so that blocks become chained together to create a permanent, unalterable record of all transactions which have been written to the blockchain since its inception. In order for a transaction to be written to the blockchain, it must be “validated” by so-called miners. The miners execute a consensus algorithm such as a proof of work algorithm to ensure that each transaction is valid, with invalid transactions rejected from the network.

The various entities participating in the blockchain system are generally referred to as network nodes. Different network nodes may provide different functionality. For instance, miners are the network nodes that validate transactions. Other network nodes provide digital wallet services to users for conducting transactions. Yet other network nodes maintain the blockchain database. Network nodes may provide a single one of these functions or multiple ones of these functions.

The different types of blockchain networks include public blockchain networks, private blockchain networks, and consortium blockchain networks. A public blockchain network is open for all entities to use and participate in the consensus process. A private blockchain network is provided for particular entity, which centrally controls read and write permissions. A consortium blockchain network is provided for a select group of entities, which control the consensus process, and includes an access control layer.

Existing blockchain platforms face issues of scalability.

### SUMMARY

In accordance with one aspect of the subject matter described herein, a method for recording a transaction between first and second transacting network nodes associated with a global blockchain is provided. In accordance with the method, first and second transacting network nodes are associated with a selected sub-chain of the global blockchain, the selected sub-chain being selected from among a plurality of sub-chains of the global sub-chain. In response to the first transacting network node causing cryptocurrency to be sent to a first public address associated with the second transacting network node as part of a given transaction between the first and second transacting network nodes, the given transaction is caused to be recorded in the selected sub-chain. Subsequent to recording the given transaction on the selected sub-chain, the transaction is caused to be recorded on the global blockchain using a second public address of the second transacting network node. The recording is performed using an atomic commit process that prevents the first and second transacting network nodes from conducting any other transactions while the given transaction is being recorded on the global blockchain.

In accordance with another aspect of the subject matter described herein, the first and second public addresses have a one-to-one relationship with one another.

In accordance with yet another aspect of the subject matter described herein, the first and second public addresses are derived from a common private key.

In accordance with another aspect of the subject matter described herein, an initialization step is performed in which the first transacting network node is associated with an initial sub-chain selected from among the plurality of sub-chains.

In accordance with another aspect of the subject matter described herein, the initial sub-chain is determined based on at least one attribute of the first transacting network node.

In accordance with another aspect of the subject matter described herein, the at least one attribute of the first transacting network node includes a geographic location of the first transacting network node.

In accordance with another aspect of the subject matter described herein, the initial sub-chain is different from the selected sub-chain and further comprising moving the first transacting network node so that it is associated with the selected sub-chain instead of the initial sub-chain.

In accordance with another aspect of the subject matter described herein, the second transacting network node is associated with the selected sub-chain in the initialization step.

In accordance with another aspect of the subject matter described herein, the second transacting network node is associated with a different sub-chain different from the initial sub-chain different from the selected sub-chain during the initialization step and further comprising moving the second transacting network node so that it is associated with the selected sub-chain instead of the different sub-chain.

In accordance with another aspect of the subject matter described herein, causing the transaction to be recorded on the global blockchain includes causing a verifying network node to record the transaction on the global blockchain, the verifying network node verifying the transaction in accordance with a zero-knowledge protocol.

In accordance with another aspect of the subject matter described herein, the verifying network node is selected from among a first subset of the network nodes in accordance with a proof of round-trip time (PoRTT) algorithm.

In accordance with another aspect of the subject matter described herein, the verifying network node is selected by an elector node selected from among a second subset of the network nodes.

In accordance with another aspect of the subject matter described herein, the elector node is selected from among a second subset of the network nodes by a consensus decision-making algorithm different from the PoRTT algorithm.

In accordance with another aspect of the subject matter described herein, at least one of the first and second transacting network nodes are initially associated with a different sub-chain different from the selected sub-chain and further comprising moving the at least one of the first and second transacting network nodes so that it is selected with the selected sub-chain in accordance with a system policy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a simplified block diagram of a blockchain system.

FIG. 2 illustrates a simplified block diagram of one example of a cryptocurrency system that includes a global blockchain and two sub-chains of the global blockchain.

### DETAILED DESCRIPTION

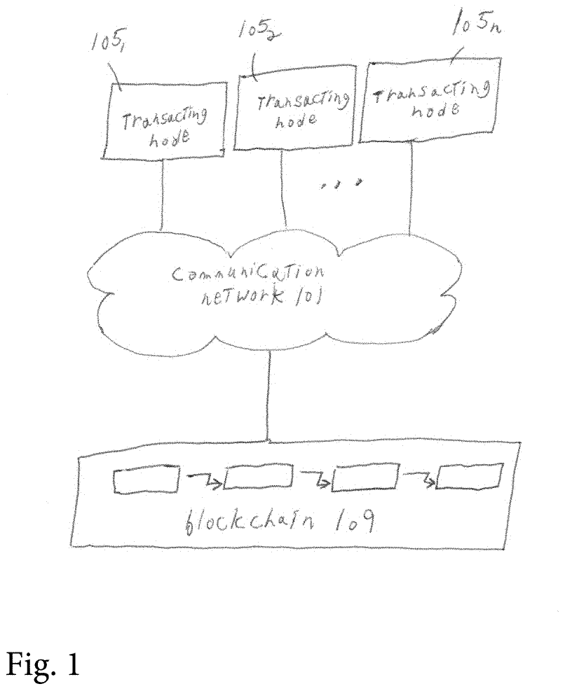

FIG. 1 illustrates a blockchain system 100 that provides a platform for network nodes 105₁, 105₂ . . . 105ₙ to exchange digital assets such as cryptocurrency. Since these network nodes are able to conduct cryptocurrency or other transactions, they will be referred to herein as transacting nodes. Network nodes 105₁, 105₂ . . . 105ₙ communicate with each other over one or more wired and/or wireless communication networks represented by communication network 101. In one implementation the communication network 101 may be the public Internet. Examples of transacting nodes may include devices such as mobile communication devices (e.g., smartphones), desktop computers, laptop computers, tablet computers, network servers, and so on.

The blockchain system 100 uses a blockchain 109 to record transactions between the various network nodes 105₁, 105₂ . . . 105ₙ. In some implementations the blockchain system 100 may be a well-known cryptocurrency platform such as, but not limited to, Bitcoin or Ethereum, for example. More generally, the system 100 may employ any blockchain platform in which transactions of any type may be conducted.

The miners (not shown in FIG. 1) group a certain number of transactions that constitute a block and verify these transactions using a consensus algorithm such as a proof of work mechanism. Once a block is verified, the verified block is combined with other blocks that have been verified previously. These blocks constitute the blockchain 109. A copy of the blockchain 109 is stored on one or more servers or other terminals and can be accessed by the other nodes in the system.

As previously mentioned, a transaction is an action carried out by a computer program that changes the state of the ledger. The locus of a transaction is the block of the ledger of a blockchain system to which the transaction may be applied. Typically, blockchains provide a “current” block that serves as the locus for transactions. A new block may be designated as the current block according to a system policy. As transactions get added to the current block, the latter fills up and at a pre-determined number of added transactions, the current block may be added to the ledger and a new current block may be designated as the locus.

In the presentation below, when only a single blockchain is being discussed we omit the term “locus” when referring to a transaction since the locus of the transaction will be clear from the context. When two or more blockchains are under discussion, we will speak of “moving” a transaction from one blockchain to another, by which terminology we refer to changing the locus of the transaction from one blockchain to another.

Transactions between the entities are defined and processed according to protocols established by each individual blockchain platform. However, many platforms define transactions in terms of a data structure that includes many similar fields. In general, a transaction typically contains a brief description of the transaction, including, for example, a hash value of the transaction, the number of inputs, the number of outputs, the size of the transaction, etc. Other fields generally include an “Input” field and an “Output” field. The “Input” field contains a reference to a previous transaction from which cryptocurrency coins are received and the “Output” field contains the number of cryptocurrency coins to be sent to a public address used by the entity that is to receive the coins.

A public address is a hashed version of a cryptographic public key. The public key forms part of a public/private key pair and so every address is linked to a private key that is owned by or associate with an entity (human, logical, virtual or computer-based entity). It should be noted that in a blockchain system 100, network nodes 105₁, 105₂ . . . 105ₙ receiving cryptocurrency may have multiple public addresses to receive the cryptocurrency.

The different public addresses of a transacting node may be generated from a set of independently generated private keys that are maintained by the digital wallet of the transacting node. Digital wallets that generate and maintain such independent private keys are sometimes referred to as nondeterministic wallets. In other cases, the private keys may be derived from a single master key referred to as the seed. All of these private keys are related to one another and may be regenerated from the original seed. Digital wallets that generate and maintain multiple private keys derived from a single seed are sometimes referred to as deterministic wallets. A private key derived from another private key is referred to as a child private key. A child private key, in turn, may serve as a parent private key to generate its own child private key. Each child private key can be used to generate a public key and a public address.

As previously mentioned, existing blockchain platforms are not easily scalable. The transaction validation and consensus mechanisms (such as proof-of-work) used in blockchain networks and other parameters such as the block-size and block-time determine how fast the network can process and confirm the transactions. While commercial payment networks can process thousands of transactions per second, blockchain networks can take from a few seconds to several minutes for a transaction to be confirmed and have much less transaction throughput as compared to commercial payment networks. For example, some versions of the Bitcoin network take 10 minutes or longer to confirm transactions and achieve about 3-7 transactions/sec throughput. Similarly, in the Ethereum blockchain network the block-time is roughly 17 seconds and achieves about 7-15 transactions/sec throughput. Furthermore, many blockchain applications require multiple confirmations for newly mined blocks to secure the transactions from “double spending.” For such applications, it may take several minutes for a transaction to be confirmed. While it is possible to make the block-times faster so that the transactions can be processed faster, this would impact network security. Fast block-times would make it impossible for average-sized miners to successfully confirm transactions on the blockchain network and only the most powerful miners would be able to afford the resources required to mine successfully. Thus, fast block-times can lead to centralization risks. There exists a tradeoff between how fast the transactions can be processed on a blockchain network and the level of decentralization that can be maintained.

To address these problems the system and techniques described herein establish sub-chains or shards of the global blockchain that may each serve a subset of nodes that would otherwise perform transactions using the global blockchain. Note that in this context the global blockchain may refer to a public blockchain, a private blockchain or a consensus blockchain. During an initialization process in which each node becomes associated with the global blockchain they each also become associated with a particular sub-chain based on one more attributes of the respective node. For instance, in one implementation the attribute may be the geographic location of the node, either when the node first registers with the system (such as when downloading a wallet application that is used in the system) or at the time the transaction is to be performed. Note that in the former case the node may be associated with a single sub-chain that remains the same even if the node changes its geographic location, whereas in the latter case the node may be associated with different sub-chains at different times depending on its geographic location at the time of the transaction. However, regardless of how the association between the nodes and sub-chains is determined, any given node in general will only be associated with a single sub-chain at any given time. In many cases nodes will be associated with the sub-chain that they are logically closest to at some given time.

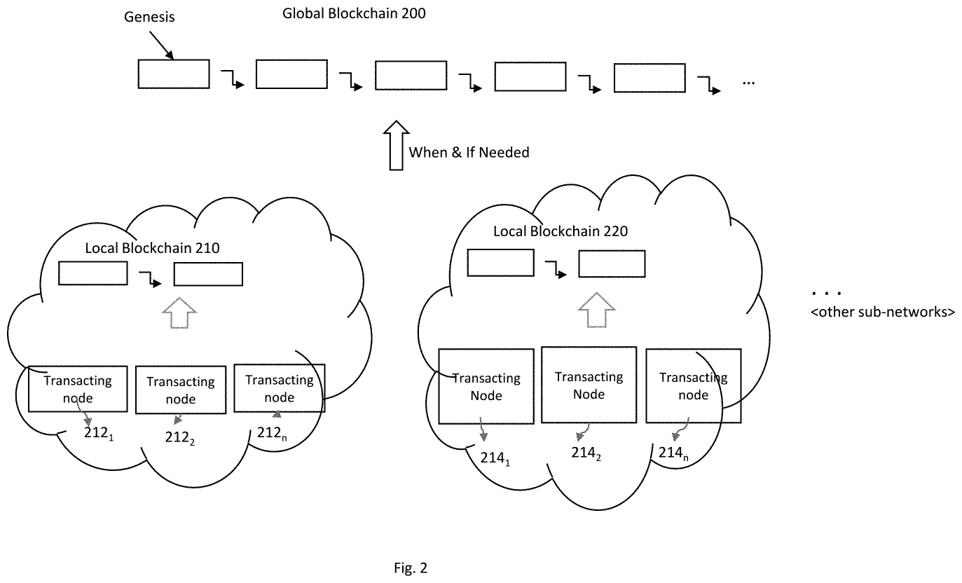

For instance, FIG. 2 shows a cryptocurrency system 200 that includes a global blockchain 200 and two sub-chains 210 and 220 of the global blockchain. In this example transacting nodes 212₁, 212₂, . . . 212ₙ (“212”) are associated with sub-chain 210 and transacting nodes 214₁, 214₂, . . . 214ₙ (“214”) are associated with sub-chain 220. While only two sub-chains are shown in this example, more generally any number of sub-chains may be employed. In this particular example the association between a sub-chain and its transacting nodes is determined by geographic location such that transacting nodes 212 are all in a common geographic region (e.g., the Eastern half of the United States) with sub-chain 210 and transacting nodes 214 are all in a common geographic region (e.g., the Western half of the United States) with sub-chain 220.

The process of performing transactions that are first recorded in a sub-chain and then transferred to the global blockchain will be illustrated with the following use cases.

In a first illustrative use case the two transacting nodes involved in the transaction are associated with the same sub-chain. For instance, this example will assume that the transaction is between transacting nodes 212₁ and 212₂, which are associated with sub-chain 210. In this example transacting node 212₁ is to send cryptocurrency to transacting node 212₂. Transacting node 212₂ provides transacting node 212₂ with a first public address that is generated using one of its private keys. This first public address can be used to record the transaction on the local sub-chain 210. The transacting node 212₁ also provides a second public address that has a one-to-one relationship with the first public address. This relationship between the two public addresses may be determined in any number of ways. For instance, in one implementation one of the private keys that is used to derive one of the public addresses may be a parent private key and the other private key used to derive the other public address may be a child of that parent private key. In this way the one-to-one relationship between the public addresses may be easily established.

At some time after recording the transaction on the local sub-chain 210, the transaction is moved from the local sub-chain 210 to the global blockchain 200 using the second public address that is associated with the global blockchain 200. In one embodiment this transfer between the local sub-chain 210 and the global blockchain 200 is accomplished using an atomic commit process that locks the two chains, i.e., the local sub-chain 210 and the global blockchain 200 while the transfer is being performed. The terms “locking the chain” and “atomic commit process” imply that no other transactions are allowed, i.e., accepted or processed, on the blockchains that involve the two nodes conducting the transaction during the time period comprising the lock, other than the specific transaction between the first public address and the second public address.

In a second illustrative use case the two transacting nodes involved in the transaction are associated with the different sub-chains. For instance, this example will assume that the transaction is between transacting node 212₁, which is associated with sub-chain 210 and transacting node 214₁, which is associated with sub-chain 220. In this example transacting node 212₁ is to send cryptocurrency to transacting node 214₁. Because these transacting nodes are on different sub-chains, it is first necessary to move them to a common sub-chain so that both are associated with sub-chain 210, sub-chain 220, or a third sub-chain with which neither transacting node initially has an association. The common sub-chain may be selected in accordance with a system policy that is implemented though the wallet application on the transacting node devices. For instance, one system policy may require that the transacting node initiating the transaction become associated with the sub-chain associated with the other transacting node.

One advantage of moving both transacting nodes to a third sub-chain which neither transacting node initially has an association is that it ensures that the locking strategy becomes effective. That is, it ensures that there will not no other transaction involving these two nodes. It also implies that the receiving node can start out with a zero balance and the initiating node can start out with exactly the balance needed for the transaction (and no more). At the end of the transaction, the initiating node will then have a zero balance and the receiving node will have the balance that was transferred.

In some embodiments it may be advantageous or even necessary to verify the results of a transaction prior to recording it on the local sub-chain. For instance, in some particular embodiments in which a cryptographic coin employed in the transaction is produced by a proof of zero-knowledge protocol, the verification confirms that the cryptographic coin employed in the transaction is produced by a proof of zero-knowledge protocol using specified service logic. Additional details concerning this particular verification process may be found in U.S. Appl. Serial No [Docket No. 12700/31], which is hereby incorporated by reference in its entirety.

The verification process is initiated when a verification request is received by one of a subset of network nodes that are referred to as elector nodes. The elector node, in turn, selects another network node from another subset of network nodes that are referred to as verifier nodes. The selected verifier node then verifies the transaction associated with the verification request, after which it may be recorded on the appropriate sub-chain when the verifying node transmits a write request to the sub-chain. The elector nodes and the verifier nodes may be any suitable ones of the nodes in the network, including, for instance, transacting nodes other than those involved in the particular transaction being verified. In general the subset of elector nodes and verifier nodes will be associated with the common sub-chain on which the transacting nodes are located.

The verification method performed by the elector and verifier nodes involved in the verification process may in some implementations include the following three phases.
1. An Elector Node Phase in which a first consensus decision-making algorithm (e.g., a proof of elapsed time (PoET) algorithm) is used to select as a leader one of the elector nodes from the subset of elector nodes.
2. A Verifier Node Phase in which a verifier node from the subset of verifier nodes is selected by the leader of the elector network using a second consensus decision-making algorithm (e.g., a proof of round trip time (PoRTT) algorithm). The selected verifier node verifies the transaction
3. An optional M-of-N (M<N) Proof of Authority Phase in which additional verifier nodes verify the proposed verification of the transaction, which was performed by the verifier node selected by the leader of the elector network.

Proof of Elapsed Time (PoET) is a consensus algorithm developed by Intel that eliminates the computationally intensive resources required by the original proof-of-work consensus algorithm and thus also eliminates the wasteful energy consumption associated with the original proof-of-work consensus algorithm. In PoET, each elector node is assigned a random wait time sampled from an exponential distribution, generated by code running inside a trusted execution environment (TEE) of the elector node. The random wait times in the PoET may instruct a verifier node to go to sleep for an interval of time based on a randomly generated number. A collection of such nodes thus goes to sleep, and each node wakes up at random time instants. Each node wakes up at a random instant of time (within 1 second). The first node to wake up is selected and referred to as the leader node.

The leader node selects a verifier node from among the subset of verifier nodes using the PoRTT consensus decision-making algorithm, which selects a verifying nodes that has a round-trip-time (RTT) falling within some predefined range (e.g. 3-5 milliseconds). The RTT is the total time taken to send the signal to the verifier node plus the time taken to receive a response to that signal. If the signal that is sent is a data packet, the RTT is also known as the ping time.

The M-of-N constraint requires that at least N members of a verifying group of M verifier nodes adhere to the stated constraint. In verification networks, the M-of-N constraint typically requires that M of N members of a group verify a proposed verification.

Additional details concerning the particular verification process described above in which elector and verifier nodes are employed to verify transactions may be found in the aforementioned U.S. Appl. Serial No. [Docket No. 12700/31].

Once a transaction has been verified by the verifier node (and optionally confirmed in an M-of-N Proof of Authority Phase), the verifier node can transmit a write request to the local sub-chain to record the information concerning the verified transaction.

Illustrative Computing Environment

As discussed above, aspects of the subject matter described herein may be described in the general context of computer-executable instructions, such as program modules, being executed by a computer. Generally, program modules include routines, programs, objects, components, logic, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

1. A method for recording a transaction between first and second transacting network nodes associated with a global blockchain, comprising:
associating first and second transacting network nodes with a selected sub-chain of the global blockchain, the selected sub-chain being selected from among a plurality of sub-chains of the global sub-chain;
in response to the first transacting network node causing cryptocurrency to be sent to a first public address associated with the second transacting network node as part of a given transaction between the first and second transacting network nodes, causing the given transaction to be recorded in the selected sub-chain; and
subsequent to recording the given transaction on the selected sub-chain, causing the transaction to be recorded on the global blockchain using a second public address of the second transacting network node, wherein the recording is performed using an atomic commit process that prevents the first and second transacting network nodes from conducting any other transactions while the given transaction is being recorded on the global blockchain.

2. The method of claim 1, wherein the first and second public addresses have a one-to-one relationship with one another.

3. The method of claim 1, wherein the first and second public addresses are derived from a common private key.

4. The method of claim 1, further comprising an initialization step in which the first transacting network node is associated with an initial sub-chain selected from among the plurality of sub-chains.

5. The method of claim 4, wherein the initial sub-chain is determined based on at least one attribute of the first transacting network node.

6. The method of claim 5, wherein the at least one attribute of the first transacting network node includes a geographic location of the first transacting network node.

7. The method of claim 4, wherein the initial sub-chain is different from the selected sub-chain and further comprising moving the first transacting network node so that it is associated with the selected sub-chain instead of the initial sub-chain.

8. The method of claim 4, wherein the second transacting network node is associated with the selected sub-chain in the initialization step.

9. The method of claim 4, wherein the second transacting network node is associated with a different sub-chain different from the initial sub-chain different from the selected sub-chain during the initialization step and further comprising moving the second transacting network node so that it is associated with the selected sub-chain instead of the different sub-chain.

10. The method of claim 1, wherein causing the transaction to be recorded on the global blockchain includes causing a verifying network node to record the transaction on the global blockchain, the verifying network node verifying the transaction in accordance with a zero-knowledge protocol.

11. The method of claim 10, wherein the verifying network node is selected from among a first subset of the network nodes in accordance with a proof of round-trip time (PoRTT) algorithm.

12. The method of claim 11, wherein the verifying network node is selected by an elector node selected from among a second subset of the network nodes.

13. The method of claim 12, wherein the elector node is selected from among a second subset of the network nodes by a consensus decision-making algorithm different from the PoRTT algorithm.

14. The method of claim 1, wherein at least one of the first and second transacting network nodes are initially associated with a different sub-chain different from the selected sub-chain and further comprising moving the at least one of the first and second transacting network nodes so that it is selected with the selected sub-chain in accordance with a system policy.
